(19) United States
(12) Patent Application Publication
(10) Pub. No.: US 2015/0226842 A1
(43) Pub. Date: Aug. 13, 2015

(54) SONAR TECHNIQUE

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/273,336

(22) Filed: May 8, 2014

Related U.S. Application Data
(60) Provisional application No. 61/821,070, filed on May 8, 2013.

(51) Int. Cl. G01S 7/52; G01S 15/89; G01S 15/02

(52) U.S. Cl. CPC G01S 7/52; G01S 15/02; G01S 15/89

(57) ABSTRACT

An improved sonar mechanism comprises an audio source from a sonar system. The audio source is processed in parallel by the following modules: a low pass filter with dynamic offset; an envelope controlled bandpass filter; a high pass filter; and adding an amount of dynamic synthesized sub bass to the source audio. The processed audio is then combined in a summing mixer with the audio source.

### CROSS-REFERENCE TO RELATED PATENT APPLICATIONS

Embodiments of the present invention relate to U.S. Provisional Application Ser. No. 61/821,070, filed May 8, 2013, entitled “AUDIO PROGRAM FOR SONAR”, the contents of which are incorporated by reference herein and which is a basis for a claim of priority.

### BACKGROUND OF THE INVENTION

Sonar (originally an acronym for Sound Navigation And Ranging) is a technique that uses sound propagation (usually underwater, as in submarine navigation) to navigate, communicate with or detect objects on or under the surface of the water, such as other vessels. Two types of technology share the name “sonar”: passive sonar is essentially listening for the sound made by vessels; active sonar is emitting pulses of sounds and listening for echoes. Sonar may be used as a means of acoustic location and of measurement of the echo characteristics of “targets” in the water. Acoustic location in air was used before the introduction of radar. Sonar may also be used in air for robot navigation, and SODAR (an upward looking in-air sonar) is used for atmospheric investigations¹. ¹ http://en.wikipedia.org/wiki/Sonar

The term sonar is also used for the equipment used to generate and receive the sound. The acoustic frequencies used in sonar systems vary from very low (infrasonic) to extremely high (ultrasonic). The study of underwater sound is known as underwater acoustics or hydroacoustics.Sound propagationSonar operation is affected by variations in sound speed, particularly in the vertical plane. Sound travels more slowly in fresh water than in sea water, though the difference is small. The speed is determined by the water's bulk modulus and mass density. The bulk modulus is affected by temperature, dissolved impurities (usually salinity), and pressure. The density effect is small. The speed of sound (in feet per second) is approximately: 4388+(11.25×temperature (in ° F.))+(0.0182×depth (in feet))+salinity (in parts-per-thousand). This empirically derived approximation equation is reasonably accurate for normal temperatures, concentrations of salinity and the range of most ocean depths². ² See, n.1, Above

Ocean temperature varies with depth, but at between 30 and 100 meters there is often a marked change, called the thermocline, dividing the warmer surface water from the cold, still waters that make up the rest of the ocean. This can frustrate sonar, because a sound originating on one side of the thermocline tends to be bent, or refracted, through the thermocline. The thermocline may be present in shallower coastal waters. However, wave action will often mix the water column and eliminate the thermocline. Water pressure also affects sound propagation: higher pressure increases the sound speed, which causes the sound waves to refract away from the area of higher sound speed. The mathematical model of refraction is called Snell's law. If the sound source is deep and the conditions are right, propagation may occur in the ‘deep sound channel’. This provides extremely low propagation loss to a receiver in the channel. This is because of sound trapping in the channel with no losses at the boundaries³. ³ See, n.1, Above

Similar propagation can occur in the surface duct under suitable conditions. However in this case there are reflection losses at the surface. In shallow water propagation is generally by repeated reflection at the surface and bottom, where considerable losses can occur. Sound propagation is affected by absorption in the water itself as well as at the surface and bottom. This absorption depends upon frequency, with several different mechanisms in sea water. Long-range sonar uses low frequencies to minimize absorption effects. The sea contains many sources of noise that interfere with the desired target echo or signature. The main noise sources are waves and shipping. The motion of the receiver through the water can also cause speed-dependent low frequency noise⁴. ⁴ See, n.1, Above

Scattering when active sonar is used occurs from small objects in the sea as well as from the bottom and surface. This can be a major source of interference. This acoustic scattering is analogous to the scattering of the light from a car's headlights in fog: a high-intensity pencil beam will penetrate the fog to some extent, but broader-beam headlights emit much light in unwanted directions, much of which is scattered back to the observer, overwhelming that reflected from the target (“white-out”). For analogous reasons active sonar needs to transmit in a narrow beam to minimize scattering. Target characteristics the sound reflection characteristics of the target of an active sonar, such as a submarine, are known as its target strength. A complication is that echoes are also obtained from other objects in the sea such as whales, wakes, schools of fish and rocks. Passive sonar detects the target's radiated noise characteristics. The radiated spectrum comprises a continuous spectrum of noise with peaks at certain frequencies, which can be used for classification⁵. ⁵ See, n.1, Above

Research has shown that use of active sonar can lead to mass stranding marine mammals. Beaked whales, the most common casualty of the stranding, have been shown to be highly sensitive to mid-frequency active sonar. Other marine mammals such as the blue whale also flee away from the source of the sonar, while naval activity was suggested to be the most probable cause of a mass stranding of dolphins. The US Navy, which part-funded some of studies, said the findings only showed behavioral responses to sonar, not actual harm, but “will evaluate the effectiveness of [their] marine mammal protective measures in light of new research findings. One of the advantages of using the MAX SOUND Program for Sonar is that since we increase intelligibility, we can lower the intensity and be much less harmful to any and all biological presences in the scanned area⁶. ⁶ See, n.1, Above

Conventional Sonar technology, it is not very efficient in its ability to locate a target every time with absolute certainty. When verifying targets, the operator must sometimes rely on multiple “readings” for comparison. This is a manual process and takes time to complete. The improved Sonar technique will allow the operator access to much more data in a shorter amount of time resulting in better accuracy and a much more efficient method of identifying desired targets over non-desirable ones. The applications for this are military, commercial, and consumer usage of ANY Sonar products. This is also the only viable solution for being less destructive to any and all biological presences, and animal life.

A new method and process is therefore required that addresses the above noted deficiencies of the conventional sonar methods.

### SUMMARY OF THE INVENTION

An improved sonar mechanism comprises receiving an audio source from a Sonar system. The audio source is processed in parallel by the following modules: a low pass filter with dynamic offset; an envelope controlled bandpass filter; a high pass filter; and adding an amount of dynamic synthesized sub bass to the source audio. The processed audio is then combined in a summing mixer with the audio source to result in a new enhanced sound wave for sonar applications.

### BRIEF DESCRIPTION OF THE DRAWINGS

FIG. 1 shows a comparison of unprocessed vs. processed wave data according to an exemplary embodiment of the present invention.

FIG. 2 is a spectrograph display of an unprocessed wave.

FIG. 3 shows an example of an original audio track from a commercial recording according to an exemplary embodiment of the present invention.

### DETAILED DESCRIPTION OF THE PREFERRED EMBODIMENT(S)

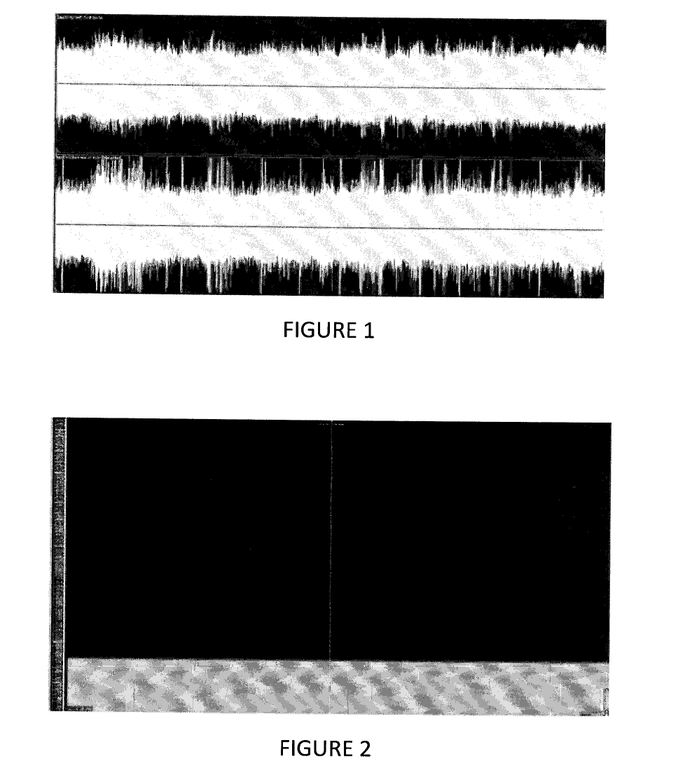

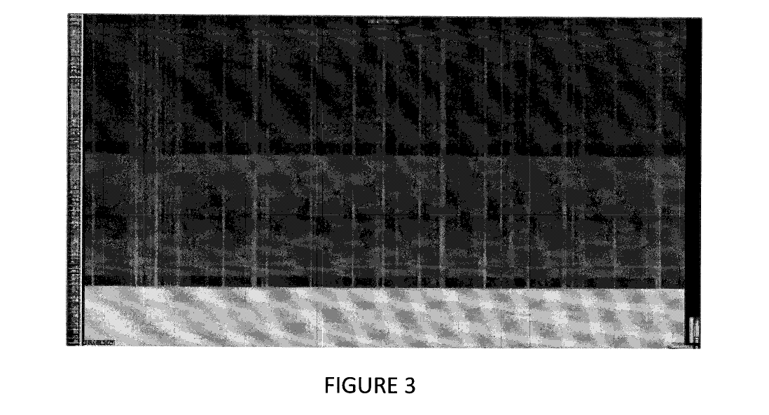

The inventive process is designed for enhancement to existing sonar systems. One skilled in the art would appreciate that the inventive method is not an APP as that term is used in the conventional sense, but the large program. The inventive process can be used to correct for and clean up phase anomalies in the transmitted or received signals to improve the performance of an existing system. In one embodiment, the inventive process id implemented as a software upgrade, or as a redesign to add to an existing Sonar system. On the receiving end, the process can clear up Sonar signals that have been compromised by water temperature, depth, or distance. The inventive process resynthesizes missing harmonic structure, phase relationships, and dynamic content and provides for a much clearer signal. (See, FIGS. 1-3).

The inventive sonar improvement process can be especially beneficial in “noisy” environments. In such environments the process can not only help by resynthesis, but can also help to “filter out” specific targets that the system may need to ignore, such as biological presences. The same can be said for identifying purposes. On the transmission end, there are a variety of applications for the inventive process. Below is a list some of these:
1.—Since the process produces a sonically “cleaner” signal, it will have better clarity and should extend the distance of travel before the signal is degraded beyond recognition. This is because the phase anomalies that hinder the wave are resynthesized, thus allowing for a cleaner and faster transmission.
2.—With the current naval technology of having a transducer coating on an entire ship, it is possible to use the process in conjunction with a receiver to either null or completely change the returned signal. This could be used to either make a vessel invisible or appear as something less strategic in the returned, resynthesized signal.
3.—Better integrity for all observed “targets” not only in class, but to individual vessels and/or cargo. The process allows for more information that can be collected, even in a compromised wave, for better identification.
4.—The process will provide for a much less impact on sea life and biological presences. The inventive process provides for a cleaner signal that doesn't rely on more transmission power, as current processes do, therefore, the impact on biological presences is far less destructive.
5.—The entire system can be converted to an encode/decode system if security requires. This would make it necessary for a specific harmonic signature to be created for system use. It isn't necessary to do this, but could be implemented if warranted.
6.—One skilled in the art would appreciate that if the goal is to make something other than a vessel invisible to sonar, it would be possible to do so by manipulating any sonar “pings” and neutralizing them using resynthesis techniques in the process.

### DETAILED DESCRIPTION OF THE INVENTION

The present invention will now be described in more detail by reference to the drawings.

According to one embodiment of the inventive Sonar enhancement process, the initial audio signal, received from a sonar system, is treated by four modules and is subsequently combined with the original audio source in a mixer.

In one embodiment, the inventive Sonar mechanism receives audio sound from a Sonar system. The original audio signal is parallel processed by one or more first processed by one or more modules. In one embodiment the original audio is parallel processed by four modules as follows. the EXPAND module shown in FIG. 2. EXPAND is a low pass filter with dynamic offset. The frequency for the low pass filter is preferably between 40 htz to 20 Khtz. preferably, the frequency is about 2000 Hertz. The setting range for EXPAND is preferably at 0-1, with intervals of 0.1. EXPAND can be preset in the program. The original audio signal is also processed by the SPACE module. SPACE comprises three blocks. The top block “SPACE” is the output level for this block. The next block is the envelope follower modulation amount, and the last block is the frequency range for SPACE block. The SPACE is an envelope controlled bandpass filter. The output amplitude for space is set in a range from about 0 to 3, preferably at about 1.8. The frequency range for SPACE can be about 1000 to about 8000 Hertz. The settings for SPACE are preferably preset.

Next, the original audio signal is processed by the SPARKLE module, which is a high band pass filter. In one embodiment, SPARKLE is comprised of three processing blocks. The top block is the output level for this block, the SPARKLE HPFC set HP filter frequency, and SPARKLE TUBE BOOST sets amount of tube simulator sound. Preferably, the frequency for the high pass filter is between 4 Khtz to about 10 Khtz. Preferably, Tube simulator ranges from 1-5. Preferably, the threshold ranges from 0-1 in 0.1 digits. The settings for SPARKLE are preferably preset.

The original audio signal is also processed by SUB BASS, which adds an amount of dynamic synthesized sub bass to the audio. The frequency of the sub bass is preferably 120 Hz to less. The four treated audio signals (EXPAND, SPACE, SPARKLE, SUB BASS) are then combined in a summing mixer to produce an audio signal with improved quality.

In more detail, EXPAND is a 4 pole digital low pass filter with an envelope follower for dynamic offset (FIXED ENVELOPE FOLLOWER). This allows the output of the filter to be dynamically controlled so that the output level is equal to whatever the input is to this filter section. (Ex.) If the level at the input is −6 dB, then the output will match that. Whenever there is a change at the input, the same change will occur at the output regardless of either positive or negative amounts. The frequency for this filter is 20 to 20 khertz, in other words it is full range. The intention of this filter is to “warm up” or provide a fuller sound as audio that passes through it. The original sound passes through, and is added to the effected sound for its output. As the input amount increases or decreases (varies), so does the phase of this section. See reference page. This applies to ALL FILTERS used in this software application. Preferably all filters are Butterworth type filters.

SPACE—In one embodiment, there are several components to this module. They are: SPACE—this amount is after the envelope follower and sets the final level of this module. This is the effected signal only, without the original. SPACE ENV FOLLOWER—tracks the input amount and forces the output level of this section to match. SPACE FC—sets the center frequency of the 4 pole digital high pass filter used in this section. This filter also changes phase as does EXPAND. SPARKLE—There are several components to this module. They are: SPARKLE HPFC—This is a 2 pole high pass filter with a preboost which sets the lower frequency limit of this filter. Anything above this setting passes through the filter while anything below is discarded or stopped from passing. SPARKLE TUBE THRESH—sets the lower level at which the tube simulator begins working. As the input increases, so does the amount of the tube sound. The tube sound is adding harmonics, compression and a slight bit of distortion to the input sound. This amount increases slightly as the input level increases. SPARKLE TUBE BOOST—sets the final level of the output of this module. This is the effected signal only, without the original.

SUB BASS—this module takes the input signal and uses a low pass filter to set the upper frequency limit to about 100 Hz. An octave divider occurs in the software that changes the input signal to lower by an octave (12 semi tones) and output to the only control in the interface, which is the level or the final amount. This is the effected signal only, without the original.

The modules go into a summing mixer which combines the audio. The levels going into the summing mixer are controlled by the various outputs of the modules listed above. As they all combine with the original signal, there is interaction in phase, time and frequencies that occur dynamically.

Advantageously, the inventive process results in a highly accurate sonic picture of a selected target area. This allows the operator to identify targets that would have been unseen without the aid of this process. The inventive process is a real-time, re-synthesis system. That restores phase relationships, harmonic content, and dynamic range; is the only truly dynamic, real-time system that does this type of acoustic processing; provides the operator a much greater degree of resolution/integrity from a lower resolution source; and can create a stereo signal from a mono source.

Sonar images produced by the inventive process will have more clarity/integrity. With the phase relationships having been restored, accuracy will increase dramatically when processed in stereo. Advantageously, the inventive process helps identify from a library of collected identities what is being seen and better determine range from own ship. Advantageously, the inventive process can be scaled down to be used in torpedo tracking so the torpedo would only track a single, specific target with great integrity (target a single vessel in the midst of others, even among the same class or type of target). Advantageously, the inventive process can record and playback any audio for as much time as there is available memory to record (to hard disk), while retaining all of the qualities produced by the inventive process. Advantageously, the inventive process assigns specific alerts (audio and/or visual) to specific targets with greater accuracy than available through current systems. Advantageously, most of the above benefits can be provided through software upgrades to existing Navy systems.

What is claimed is:

1. An improved sonar mechanism comprising:
An audio source from a sonar system;
Processing the audio source by the following modules:
a low pass filter with dynamic offset;
an envelope controlled bandpass filter;
a high pass filter; and
adding an amount of dynamic synthesized sub bass to the audio;
Combining the processed audio signals in a summing mixer with the audio source.

2. The mechanism of claim 1, wherein the number of modules is four.

3. The mechanism of claim 1, wherein the low pass filter has a ranage of 40 htz to 20 Khtz.

4. The mechanism of claim 1, wherein the envelope controlled bandpass filter comprises three processing blocks as follows: an envelope follower modulation amount; a frequency range; and an output block.

5. The mechanism of claim 1, wherein the high pass filter comprises three processing blocks as follows: an HP filter frequency; a tube simulator sound block; and an output block.

6. The mechanism of claim 1, wherein the sub bass has a frequency of 120 Htz or less.
